(19) United States
(12) Patent Application Publication
(10) Pub. No.: US 2020/0071578 A1
(43) Pub. Date: Mar. 5, 2020

(54) METHOD FOR MAKING SILICONE PRESSURE SENSITIVE ADHESIVE

(71) Applicant: DOW (SHANGHAI) HOLDING CO., LTD., Shanghai (CN)

(72) Inventors: Junping HUO, Shanghai (CN); Zhihua LIU, Shanghai (CN); Jiayin ZHU, Shanghai (CN)

(73) Assignee: Dow (Shanghai) Holding Co., Ltd., Shanghai (CN)

(21) Appl. No.: 16/348,218

(22) PCT Filed: Jan. 17, 2017
(86) PCT No.: PCT/CN2017/071405

§ 371 Date: May 8, 2019

(51) Int. Cl. C09J 183/04; C09J 5/06; C09J 5/02

(52) U.S. Cl. CPC C09J 183/04; C08G 77/20; C09J 5/02; C09J 5/06

(57) ABSTRACT

A method for making a pressure sensitive adhesive curable composition is performed at a temperature no greater than 35° C. The method includes the steps of 1) mixing starting materials including A) >0 to 40 weight parts of a polyorganosiloxane resin; B) 60 to <100 weight parts of a silanol-terminated polydiorganosiloxane C) >30% to <100% by weight, based on the combined weights of starting materials A, B, and C of an organic solvent, thereby forming a mixture; 2) adding to the mixture a starting material D) an amino-functional alkoxysilane; 3) adding, after step 2), a starting material E) a silyl phosphate compound, thereby preparing a pressure sensitive adhesive composition; and 4) adding to the pressure sensitive adhesive composition, a starting material comprising F) an organic peroxide compound, thereby forming the pressure sensitive adhesive curable composition.

### CROSS REFERENCE TO RELATED APPLICATIONS

None.

### TECHNICAL FIELD

A method is useful for preparing a pressure sensitive adhesive curable composition. The pressure sensitive adhesive prepared by curing said composition is useful in electronics applications for protection and/or masking during processing.

### BACKGROUND

A pressure-sensitive adhesive film comprising an adhesive layer on a substrate can be made using an addition reaction curable composition. The layer is made of a silicone composition comprising (A) a diorganopolysiloxane having at least two alkenyl and phenyl groups, (B) an organopolysiloxane comprising R¹₃SiO_{0.5} and SiO₂ units, (C) an organohydrogenpolysiloxane containing at least three SiH groups, (D) a retarder, (E) an addition reaction catalyst, and (F) an organic solvent. However, typical addition reaction catalysts for such silicone compositions include platinum group metals, which are expensive and add cost to the product.

A peroxide-curable silicone-based pressure-sensitive adhesive composition comprises (A) a diorganopolysiloxane having silicon bonded-alkenyl groups at both molecular terminals, (B) an organopolysiloxane resin having one or more silanol(OH)groups in one molecule and consisting of R³₂(OH)SiO_{1/2} units (where R³ independently stands for non-substituted or substituted monovalent hydrocarbon groups having 1 to 10 carbon atoms, R³₃SiO_{1/2} units (wherein R³ is the same as defined above), and SiO_{4/2} units, used in an amount of 10 to 200 parts by weight; and (C) one or more types of organic peroxide compounds used in a catalytic quantity. The peroxide-curable silicone-based pressure-sensitive adhesive composition can be prepared by mixing components (A) through (C). However, a peroxide-cured silicone-based pressure-sensitive adhesive prepared from this composition may suffer from the drawbacks of having insufficient crosslinking density, resulting in poor cohesion, and the pressure-sensitive adhesive may not have good adhesion stability and good wettability, which are properties useful for protective film applications.

### SUMMARY

A method for making a pressure sensitive adhesive curable composition comprises:

1) mixing starting materials comprising
A) >0 to 40 weight parts of a polyorganosiloxane resin comprising units of formulae
(R¹₃SiO_{1/2})_{b}(SiO_{4/2})_{c}(HOSiO_{3/2})_{d}, where each R¹ is independently a monovalent hydrocarbon group of 1 to 10 carbon atoms, subscript b is >0, subscript c is >0, and subscript d>0, with the proviso that subscripts b, c, and d have combined values such that the polyorganosiloxane resin has a number average molecular weight of at least 1,000 and a hydroxyl content of 0.1% to 4%, based on weight of the polyorganosiloxane resin;
B) a polydiorganosiloxane comprising
   i) 60 to <100 weight parts of a silanol-terminated polydiorganosiloxane of formula:

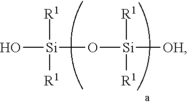

where each R¹ is independently a monovalent hydrocarbon group of 1 to 10 carbon atoms, and subscript a has a value sufficient to give the silanol-terminated polydiorganosiloxane a viscosity of 100 to 200,000 centipoise at 25° C.; and
ii) 0 to 250 weight parts of a silanol terminated polydiorganosiloxane gum having at least two pendent aliphatically unsaturated hydrocarbon groups bonded to silicon atoms per molecule, where the polydiorganosiloxane gum has unit formula (HOR¹⁰2SiO_{1/2})₂(R¹⁰2SiO_{2/2})ₑ(R¹⁰R¹¹SiO_{2/2})_{f}, where subscript e is 0 or greater, subscript f is at least 2, with the proviso that a quantity (e+f) is sufficient to give the silanol terminated polydiorganosiloxane gum a weight average molecular weight of 300,000 to 1,300,000, each R¹⁰ is independently a monovalent hydrocarbon group free of aliphatic unsaturation, and each R¹¹ is independently an aliphatically unsaturated monovalent hydrocarbon group of 2 to 10 carbon atoms; where the starting materials A) and B) are present in amounts sufficient to provide a quantity (A+B i)=100 weight parts, and a weight ratio for amounts of A) and B) of 0<A/B≤0.3; and
C) >30% to <100% by weight, based on the combined weights of starting materials A, B, and C of an organic solvent, thereby forming a mixture;

2) adding to the mixture a starting material comprising D) an amino-functional alkoxysilane;

3) adding, after step 2), a starting material comprising E) a silyl phosphate compound, thereby preparing a pressure sensitive adhesive composition; and

4) adding to the pressure sensitive adhesive composition, a starting material comprising F) a radical cure catalyst comprising an organic peroxide compound, thereby forming the pressure sensitive adhesive curable composition. In this method, at least steps 1), 2), and 3) of the method are performed at a temperature no greater than 35° C.

### DETAILED DESCRIPTION OF THE INVENTION

Starting material A) used in the method is a polyorganosiloxane resin comprising units of formulae: (R¹₃SiO_{1/2})_{b}(SiO_{4/2})_{c}(HOSiO_{3/2})_{d}, where each R¹ is independently a monovalent hydrocarbon group of 1 to 10 carbon atoms, and subscript b is >0, subscript c is >0, and subscript d>0, with the proviso that subscripts b, c, and d have combined values such that the resin has a number average molecular weight of at least 1,000 and a hydroxyl content of 0.1% to 4%, alternatively 0.25% to 2.8%, based on weight of the polyorganosiloxane resin. The concentration of silanol groups present in the silicone resin can be determined using Fourier Transfer Infra Red (FTIR).

Suitable monovalent hydrocarbon groups for R¹ include, but are not limited to, an alkyl group of 1 to 6 carbon atoms, an alkenyl group of 2 to 6 carbon atoms, and an aryl group of 6 to 10 carbon atoms. Suitable alkyl groups for R¹ are exemplified by, but not limited to, methyl, ethyl, propyl (e.g., iso-propyl and/or n-propyl), butyl (e.g., isobutyl, n-butyl, tert-butyl, and/or sec-butyl), pentyl (e.g., isopentyl, n-pentyl, and/or tert-pentyl), hexyl (including branched and/or linear isomers thereof). Suitable alkenyl groups for R¹ are exemplified by but not limited to vinyl, allyl, propenyl (e.g., iso-propenyl and/or n-propenyl), butenyl (e.g., iso-butenyl, n-butenyl, tert-butenyl, and/or sec-butenyl), pentenyl (e.g., iso-pentenyl, n-pentenyl, and/or tert-pentenyl), and hexenyl (including branched and linear isomers thereof). Suitable aryl groups for R¹ are exemplified by, but not limited to, phenyl, tolyl, xylyl, naphthyl, benzyl, and dimethyl phenyl. Suitable monovalent halogenated hydrocarbon groups for R¹ include, but are not limited to, a halogenated alkyl group of 1 to 6 carbon atoms, or a halogenated aryl group of 6 to 10 carbon atoms. Suitable halogenated alkyl groups for R¹ are exemplified by, but not limited to, the alkyl, alkenyl, and/or aryl groups described above where one or more hydrogen atoms is replaced with a halogen atom, such as F or Cl. For example, fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl are examples of suitable halogenated alkyl groups. Halogenated alkenyl groups include chloroallyl. Suitable halogenated aryl groups for R¹ are exemplified by, but not limited to, chlorobenzyl and fluorobenzyl. Alternatively, each R¹ is independently methyl, ethyl or propyl. Alternatively, each R¹ is independently selected from methyl, ethyl, vinyl, or phenyl. Each instance of R¹ may be the same or different. Alternatively, each R¹ is a methyl group.

Alternatively, subscript d may have a value such that the polyorganosiloxane resin contains 3.0% or less, alternatively 0.7% or less, alternatively 0.3% or less, of units represented by formula HOSiO_{3/2}. Alternatively, each R¹ may be an alkyl group or an aryl group. Alternatively, each R¹ may be an alkyl group. The polyorganosiloxane resin may have a molar ratio of M units to Q units (M:Q) ranging from 0.5:1 to 1.5:1, where in the unit formulae above, (R¹₃SiO_{1/2})_{b} represents M units and (SiO_{4/2})_{c} represents Q units. These mole ratios are conveniently measured by Si²⁹ NMR spectroscopy. This technique is capable of quantitatively determining the concentration of M and Q units derived from polyorganosiloxane resin and from the neopentamer, Si(OSiR¹₃)₄, present in the polyorganosiloxane resin, in addition to the total hydroxyl content of the polyorganosiloxane resin.

The polyorganosiloxane resin is soluble in solvents such as liquid hydrocarbons exemplified by benzene, toluene, xylene, and heptane, or in liquid organosilicon compounds such as a low viscosity cyclic and linear polydiorganosiloxanes.

The number average molecular weight (Mn) of the polyorganosiloxane resin can depend at least in part on the type monovalent hydrocarbon group selected for group R¹. The Mn of the polyorganosiloxane resin may be greater than or equal to 1,000, alternatively 1,000 to 5,000, alternatively 2,500 to 4,500, alternatively 3,200 to 5,000, and alternatively 2,500 to 2,700. Number average molecular weight may be measured by gel permeation chromatography (GPC). The polyorganosiloxane resin may have a hydroxyl content of 0.1% to 5%, based on the weight of starting material A), alternatively, 0.25% to 2.8% based on the weight of starting material A). Alternatively, the polyorganosiloxane resin may have a weight average molecular weight of 3,000 to 7,000.

Starting material A) may be one polyorganosiloxane resin. Alternatively, starting material A) may be two or more polyorganosiloxane resins that differ in at least one property such as structure, selection of groups for R¹, silanol content, and values for any of subscripts, b, c, and d.

The polyorganosiloxane resin can be prepared by any suitable method. Polyorganosiloxane resins of this type have been prepared by cohydrolysis of the corresponding silanes or by silica hydrosol capping methods known in the art. Briefly stated, the method involves reacting a silica hydrosol under acidic conditions with a hydrolyzable triorganosilane such as trimethylchlorosilane, a siloxane such as hexamethyldisiloxane, or a combination thereof, and recovering a product comprising M and Q units (MQ resin). The resulting MQ resins may contain from 2% to 5% percent by weight of silicon-bonded hydroxyl groups.

The intermediates used to prepare the MQ silicone resin may be triorganosilanes of the formula R¹SiR², where R² represents a hydrolyzable substituent, and either a silane with four hydrolyzable substituents such as halogen, alkoxy or hydroxyl, or an alkali metal silicate such as sodium silicate.

In some embodiments, it may be desirable that the amount of silicon-bonded hydroxyl groups (i.e., HOSiO_{3/2} groups) in the MQ silicone resin be below 0.7% by weight of the total weight of the MQ silicone resin, alternatively below 0.3%. Silicon-bonded hydroxyl groups formed during preparation of the MQ silicone resin are converted to trihydrocarbylsiloxy groups or a hydrolyzable group by reacting the MQ silicone resin with a silane, disiloxane or disilazane containing the appropriate terminal group. Silanes containing hydrolyzable groups may be added in excess of the stoichiometric quantity of the silicon-bonded hydroxyl groups of the MQ silicone resin.

Various suitable MQ resins for use in the method herein are commercially available from sources such as Dow Corning Corporation of Midland, Mich., U.S.A., Momentive Performance Materials of Albany, N.Y., U.S.A., and Bluestar Silicones USA Corp. of East Brunswick, N.J., U.S.A. For example, DOW CORNING® MQ-1600 Solid Resin, DOW CORNING® MQ-1601 Solid Resin, and DOW CORNING® 1250 Surfactant, DOW CORNING® 7466 Resin, and DOW CORNING® 7366 Resin, all of which are commercially available from Dow Corning Corporation, are suitable for use in the methods described herein. Alternatively, a resin containing M, T, and Q units may be used, such as DOW CORNING® MQ-1640 Flake Resin, which is also commercially available from Dow Corning Corporation. Such resins may be supplied in organic solvent.

Starting material B) in used in the method described herein is at least one polydiorganosiloxane selected from i) a silanol-terminated polydiorganosiloxane, and ii) a silanol terminated polydiorganosiloxane gum having at least two pendent aliphatically unsaturated hydrocarbon groups bonded to silicon atoms per molecule.

Starting material B i) is a silanol terminated polydiorganosiloxane. Starting material B i) comprises a silanol-terminated polydiorganosiloxane of formula:

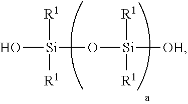

where each R¹ is as described above, and subscript a has a value sufficient to give the silanol-terminated polydiorganosiloxane a viscosity of 100 to 200,000 milliPascal·seconds (mPa·s) at 25° C. Alternatively, subscript a has a value sufficient to give the silanol-terminated polydiorganosiloxane a viscosity of 5,000 mPa·s to 100,000 mPa·s, and alternatively 50,000 mPa·s to 80,000 mPa·s.

Starting material B i) may be one silanol-terminated polydiorganosiloxane or a combination of two or more silanol-terminated polydiorganosiloxanes that differ in at least one property such as molecular weight, selection of groups for R¹, and alkenyl group content. Alternatively, starting material B i) may comprise a silanol-terminated polydialkylsiloxane and a silanol-terminated (dialkyl/alkylalkenylsiloxane) copolymer. Exemplary silanol-terminated polydialkylsiloxanes are silanol-terminated polydimethylsiloxanes, and exemplary silanol-terminated (dialkyl/alkylalkenylsiloxane) copolymers include silanol-terminated poly(dimethylsiloxane/methyvinylsiloxane) copolymers. Silanol-terminated polydiorganosiloxanes suitable for use as starting material B i) may be prepared by methods known in the art, such as hydrolysis and condensation of the corresponding organohalosilanes or equilibration of cyclic polydiorganosiloxanes.

Starting material B ii) is an optional silanol-terminated polydiorganosiloxane gum having at least two pendent aliphatically unsaturated hydrocarbon groups bonded to silicon atoms per molecule. The silanol terminated polydiorganosiloxane gum has unit formula: (HOR¹⁰₂SiO_{1/2})₂(R¹⁰₂SiO_{2/2})ₑ(R¹⁰R¹¹SiO_{2/2})_{f}, where subscript e is 0 or greater, subscript f is at least 2, with the proviso that a quantity (e+f) is sufficient to give the silanol terminated polydiorganosiloxane gum a weight average molecular weight of 300,000 to 1,300,000; alternatively 400,000 to 600,000; and alternatively 500,000.

Number average molecular weight may be measured by GPC. Each R¹⁰ is independently a monovalent hydrocarbon group free of aliphatic unsaturation, such as the alkyl groups and aryl groups described above for R¹, and each R¹¹ is independently an aliphatically unsaturated monovalent hydrocarbon group of 2 to 10 carbon atoms, such as an alkenyl group, e.g., vinyl, allyl or hexenyl. Starting material B ii) may be one silanol-terminated polydiorganosiloxane gum or a combination of two or more silanol-terminated polydiorganosiloxane gums that differ in at least one property such as molecular weight, selection of groups for R¹, and alkenyl group content. Starting material B ii) may be added in step 1) in an amount of 0 to 250 weight. Alternatively, starting material B ii) may be present in an amount of >0 to 200 weight parts, alternatively 50 to 180 weight parts, alternatively 80 to 160, and alternatively 120 to 160 weight parts.

Starting materials A) and B) (i.e., where the amount of starting material B) is the sum of the amount of starting material B i) and the amount of starting material B ii)) are present in step 1) in amounts sufficient to provide a polyorganosiloxane resin to polydiorganosiloxane weight ratio (A/B) of 0.3≥A/B>0; alternatively 0.2≥A/B≥0.1. Starting material A) and starting material B i) are present in step 1) in a combined amount totaling 100 weight parts. Starting material A) is present in an amount of 60 to <100 weight parts, and starting material B i) is present in an amount >0 to 40 weight parts. Alternatively, starting material B i) is present in an amount >0 to 30 weight parts, alternatively starting material B i) is present in an amount >0 to 10 weight parts, alternatively starting material B i) is present in an amount 5 to 20 weight parts, alternatively starting material B i) is present in an amount 5 to 10 weight parts, and alternatively starting material B i) is present in an amount 10 to 20 weight parts; in each instance with the balance to 100 weight parts being starting material A).

Starting material C) is an organic solvent. Starting material C) may be a hydrocarbon, a ketone, an ester acetate, an ether, a cyclic siloxane having an average degree of polymerization from 3 to 10, and/or a halogenated hydrocarbon. Suitable hydrocarbons for starting material C) can be i) an aromatic hydrocarbon such as toluene or xylene; ii) an aliphatic hydrocarbon such as hexane, heptane, octane, or iso-paraffin; or a combination thereof. Suitable ketones include acetone, methyl ethyl ketone, or methyl isobutyl ketone. Suitable ester acetates include ethyl acetate or isobutyl acetate. Suitable ethers include diisopropyl ether or 1,4-dioxane. Suitable cyclic siloxanes having a degree of polymerization from 3 to 10, alternatively 3 to 6, include hexamethylcyclotrisiloxane, octamethylcyclotetrasiloxane, and/or decamethylcyclopentasiloxane. Suitable halogenated hydrocarbons include trichloroethylene; per-chloroethylene; trifluoromethylbenzene; 1,3-bis(trifluoromethyl)benzene; and/or methylpentafluorobenzene. The exact amount of solvent can vary depending on the types and amounts of starting materials A) and B) and the type of solvent selected for starting material C), however, the amount of solvent may be selected such that mixing in step 1) produces a homogenous mixture. The amount of solvent may be >30% to <100%, alternatively 40% to 90%, alternatively 50% to 80%, based on combined weights of starting materials A), B), and C).

Starting material D) is an amino-functional alkoxysilane. Without wishing to be bound by theory, it is thought that the amino-functional alkoxysilane may act as a base catalyst and/or a crosslinker in the pressure sensitive adhesive composition. The amino-functional alkoxysilane may have formula: R⁵_{g}Si(OR⁶)_{(3-g)}, where subscript g is 1 or 2, each R⁶ is independently an alkyl group of 1 to 6 carbon atoms, and each R⁵ is an amino-functional hydrocarbon group. Alternatively, subscript g is 1. Alternatively, R⁵ is an amino-functional alkyl group comprising amino ethyl, amino isopropyl, and/or amino isobutyl. Alternatively, each R⁶ is methyl or ethyl. Exemplary amino-functional alkoxysilanes include, for example, N-gamma-aminopropyltriethoxysilane, N-beta-aminoethyl-gamma-aminoisobutyltrimethoxysilane, and N-beta-aminoethyl-gammaminopropyltrimethoxysilane.

Starting material D) may comprise one amino-functional alkoxysilane or a combination of two or more amino-functional alkoxysilanes that differ in at least one property such as selection and number of alkoxy groups per molecule and selection of the amino-functional group. The amount of starting material D) added during the method depends on various factors including the type and amount of amino-functional alkoxysilane and the selection of starting materials A) and B). However, the amount of starting material D) may be 0.1% to 1.0%, alternatively 0.2% to 0.8%, and alternatively 0.3% to 0.7% based on combined weights of starting materials A), B), D), and E).

Starting material E) is a silyl phosphate compound. Without wishing to be bound by theory, it is thought that the silyl phosphate compound may act as an acid neutralizing agent for the amino-functional alkoxysilane and/or as a catalyst for reaction of hydroxyl groups on other starting materials. The silyl phosphate compound may have average formula:

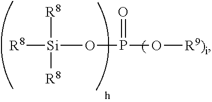

where each subscript h is 0, 1, 2, or 3; each subscript i is 0, 1, 2, or 3; and with the provisos that a quantity (h+i)=3 and subscript h has an average value greater than 0. In this formula, each group R⁸ is independently a monovalent hydrocarbon group of 1 to 6 carbon atoms. Each R⁹ is independently a hydrogen atom or a monovalent hydrocarbon group of 1 to 6 carbon atoms. Examples of monovalent hydrocarbon groups for R⁸ and R⁹ are as described above for R¹. Alternatively, subscript h has an average value of at least 1, alternatively subscript h has an average value ranging from greater than 0 and less than 2, and alternatively subscript h has an average value ranging from 1 to less than 2. Alternatively, each group R⁸ is independently an alkyl group of 1 to 4 carbon atoms. Alternatively, each R⁹ is independently a hydrogen atom or an alkyl group of 1 to 4 carbon atoms. Alternatively each R⁸ may be methyl. Alternatively, each R⁹ may be a hydrogen atom. Examples of silyl phosphate compounds for starting material E) include trimethylsilyl hydrogen phosphate or tris(trimethylsilyl)phosphate, which is available from Sigma-Aldrich Corp. of St. Louis, Mo., U.S.A.

Starting material E) may comprise one silyl phosphate compound or a combination of two or more silyl phosphate compounds. The amount of starting material E) added during the method depends on various factors including the type and amount of silyl phosphate selected, the selection of starting materials A) and B), and the type and amount of starting material D). However the amount of starting material E) may be 0.1% to 1.0%, alternatively 0.2% to 0.7%, and alternatively 0.3% to 0.6% based on combined weights of starting materials A), B), and D), based on combined weights of starting materials A), B), D), and E).

Starting material F) is a radical cure catalyst comprising an organic peroxide compound. Suitable organic peroxide compounds include benzoyl peroxide; 4-monochlorobenzoyl peroxide; dicumyl peroxide; tert-butylperoxybenzoate; tert-butyl cumyl peroxide; tert-butyloxide 2,5-dimethyl-2,5-di-tert-butylperoxyhexane; 2,4-dichlorobenzoyl peroxide; di-tertbutylperoxy-diisopropyl benzene; 1,1-bis(tert-butylperoxy)-3,3,5-trimethylcyclohexane; 2,5-di-tert-butylperoxyhexane-3,2,5-dimethyl-2,5-bis(tert-butylperoxy) hexane, or cumyl-tert-butyl peroxide. When starting material F) comprises the organic peroxide compound, starting material F) may be one organic peroxide compound or a combination of two or more organic peroxide compounds.

Starting material F) may comprise one radical cure catalyst or a combination of two or more radical cure catalyst. The amount of starting material F) added to the pressure sensitive adhesive curable composition depends on various factors including the type and amount of catalyst selected and the selection of starting materials A) and B), however, starting material F) may be present in an amount of 1 to 7 parts by weight, alternatively 2 to 6 parts by weight, alternatively 3 to 5 parts by weight, per 100 parts by weight of starting materials A) and B) combined.

Starting material G) is an optional co-solvent. Without wishing to be bound by theory, it is thought that the co-solvent may act as a co-solvent for the hydrocarbon solvent C) described above, as a solvent for water and/or other side products during steps 2) and/or 3), or both. The co-solvent comprises an alcohol. The alcohol may be, for example, methanol, ethanol, propanol (e.g., iso-propanol and/or n-propanol), or butanol (branched and linear isomers thereof). The amount of co-solvent may be 0 to 5%, alternatively 0 to 2%, alternatively 1% to 5%, and alternatively 1% to 2%, based on combined weights of starting materials A), B), C), D), E), and G).

At least steps 1) to 3) of the method described herein are performed at a temperature no greater than 35° C. Alternatively, all of the method steps for making the pressure sensitive adhesive curable composition are performed at a temperature no greater than 35° C. Alternatively, the temperature may be 00° C. to 35° C., alternatively 0° C. to 30° C., alternatively 5° C. to 30° C., alternatively 10° C. to 25° C., alternatively 15° C. to 25° C.

The method described above may further comprise one or more additional steps. The pressure sensitive adhesive curable composition prepared as described above may be used to form an adhesive article, e.g. a pressure sensitive adhesive (prepared by curing the pressure sensitive adhesive curable composition described above) on a substrate. The method described above may, therefore, further comprise comprises applying the pressure sensitive adhesive curable composition to a substrate.

Applying the pressure sensitive adhesive curable composition to the substrate can be performed by any convenient means. For example, the pressure sensitive adhesive curable composition may be applied onto a substrate by gravure coater, offset coater, offset-gravure coater, roller coater, reverse-roller coater, air-knife coater, or curtain coater.

The substrate can be any material that can withstand the curing conditions (described below) used to cure the pressure sensitive adhesive curable composition to form the pressure sensitive adhesive on the substrate. For example, any substrate that can withstand heat treatment at a temperature equal to or greater than 150° C. is suitable. Examples of materials suitable for such substrates including plastic films such as polyimide (PI), polyetheretherketone (PEEK), polyethylene naphthalate (PEN), liquid-crystal polyarylate, polyamideimide (PAI), polyether sulfide (PES), or polyethylene terephthalate (PET), or PE (polyethene), or PP (polypropylene); Alternatively, the substrate may be a metal foil such as aluminum foil or copper foil. The thickness of the substrate is not critical, however, the thickness may range from 5 micrometers to 300 micrometers when the pressure sensitive adhesive will be used in electronics applications.

To improve bonding of the pressure sensitive adhesive to the substrate, the method may optionally further comprise treating the substrate before applying the pressure sensitive adhesive composition. Treating the substrate may be performed by any convenient means, such as applying a primer, or subjecting the substrate to corona-discharge treatment, etching, or plasma treatment before applying the pressure sensitive adhesive curable composition to the substrate.

An adhesive article such as a film or tape may be prepared by applying the pressure sensitive adhesive curable composition described above onto the substrate described above. The method may optionally further comprise removing the all, or a portion, of the solvent before and/or during curing. Removing solvent may be performed by any convenient means, such as heating at a temperature that vaporizes the solvent without fully curing the pressure sensitive adhesive composition, e.g., heating at a temperature of 70° C. to 120° C., alternatively 50° C. to 100° C., and alternatively 70° C. to 80° C. for a time sufficient to remove all or a portion of the solvent (e.g., 30 seconds to 1 hour, alternatively 1 minute to 5 minutes). The method then further comprises curing the pressure sensitive adhesive curable composition (which may have some or all of the solvent removed when the drying step is performed) room temperature or by heating at a temperature of 140° C. to 220° C., alternatively 150° C. to 220° C., alternatively 160° C. to 200° C., and alternatively 165° C. to 180° C. for a time sufficient to cure the pressure sensitive adhesive curable composition (e.g., for 30 seconds to an hour, alternatively 1 to 5 minutes). This forms a pressure sensitive adhesive on the substrate. Drying and/or curing may be performed by placing the substrate in an oven. The amount of the composition to be applied to the substrate depends on the specific application, however, the amount may be sufficient such that after curing thickness of the pressure sensitive adhesive may be 5 micrometers to 200 micrometers, and for masking tape applications the thickness may be 10 micrometers to 50 micrometers.

The adhesive article (e.g., masking tape or protective film) prepared as described above is suitable for use in electronics application as a protective tape with low adhesion and good adhesion stability. The protective tape may be used, for example, as a carrier tape for a die-cutting process. Without wishing to be bound by theory, it is thought that the pressure sensitive adhesive prepared from the pressure sensitive adhesive curable composition and process described herein will have a better cost performance as compared to protective tapes prepared with hydrosilylation curable pressure sensitive adhesive compositions for protective tape applications.

The method described herein may optionally further comprise applying a removable release liner to the pressure sensitive adhesive opposite the substrate, e.g., to protect the pressure sensitive adhesive before use of the adhesive article.

### EXAMPLES

These examples are intended to illustrate some embodiments of the invention and should not be interpreted as limiting the scope of the invention set forth in the claims. Reference examples should not be deemed to be prior art unless so indicated.

The following starting materials were used in the examples.

TABLE 1
Starting Materials

| Starting | |
|---|---|
| Material | Chemical Description |
| A1 | OH-capped trimethylsiloxy MQ resin, with number average |
| | molecular weight (Mn) of 2,700 as measured by GPC and 2.8% |
| | OH content and Methyl-capped trimethylsiloxy MQ resin, with |
| | Mn 3,200 and 0.25% OH content |
| B i 1 | Silanol-terminated polydimethylsiloxane with viscosity of |
| | 80,000 mPa · s at 25° C. |
| B ii 1 | Silanol-terminated poly(dimethylsiloxane/methylvinylsiloxane) |
| | copolymer having weight average molecular weight of 500,000 |
| | and 0.09% vinyl content |
| C1 | Toluene and Xylene mixture |
| D1 | Aminoethylaminopropyltrimethoxysilane |
| D2 | Potassium hydroxide (KOH) |
| E1 | 24% trimethylsilyl dihydrogen phosphate and 68% |
| | (trimethylsilyl)hydrogen phosphate mixture; 4% |
| | hexamethyldisiloxane & 4% tris(trimethylsilyl) phosphate |
| E2 | HCl |
| F1 | Benzoyl peroxide |
| G1 | Isopropanol |

### Example 1—Preparation of Pressure Sensitive Adhesive Compositions

Starting materials A1, B i 1 (and B ii 1, if any), and C1 (and G1, if any) were combined and mixed. Starting material D1 was added, and the resulting mixture was mixed for 3 to 5 hours. Starting material E1 was added, and the resulting mixture was mixed for 2 to 3 hours. A/B ratio (as defined above) and the nonvolatile content (i.e., total amount of silicon containing starting materials) were calculated. The amounts of each starting material (in weight parts) and the calculated values are shown in Table 2, below.

TABLE 2
Weight Parts of Each Starting Material

| Starting | Sample | | | | |
|---|---|---|---|---|---|
| Material | 1 | 2 | 3 | 4 | 5 |
| A1 | 23.1 | 23.1 | 9.1 | 16.6 | 37.5 |
| B i 1 | 76.9 | 76.9 | 90.9 | 83.4 | 62.5 |
| B ii 1 | 153.8 | 153.8 | 0 | 83.4 | 125 |
| C1 | 492 | 492 | 99.7 | 280 | 404 |
| C1/(A + B + | 83% | 83% | 50% | 73.4% | 80% |
| C) | | | | | |
| D1 | 0.75 | 0.75 | 0.2 | 0.38 | 0.51 |
| D1/(A + B + | 0.7% | 0.7% | 0.2% | 0.4% | 0.5% |
| D + E) | | | | | |
| E1 | 0.3 | 0.6 | 0.16 | 0.38 | 0.51 |
| E1/(A + B + | 0.3% | 0.6% | 0.16% | 0.4% | 0.5% |
| D + E) | | | | | |
| G1 | 0 | 0 | 0 | 5.6 | 6.4 |
| G1/(A + B + | | | | 1.4% | 1.2% |
| C + D + E + G) | | | | | |
| Nonvolatile | 34% | 34% | 50% | 39% | 35% |
| Content (NVC) | | | | | |
| A/B ratio | 0.1 | 0.1 | 0.1 | 0.1 | 0.2 |

### Example 2—Preparation of Pressure Sensitive Adhesive Curable Compositions

A solution of benzoyl peroxide in solvent was prepared by mixing, 2 weight parts of benzoyl peroxide F1) and 65 weight parts of toluene and xylene mixture C1) for 3 to 5 minutes. Next, the above solution was added to each sample (at 100 weight parts) prepared as described in example 1.

TABLE 3

| | Sample | | | | |
|---|---|---|---|---|---|
| | 1 | 2 | 3 | 4 | 5 |
| Weight parts of solvent | 60 | 60 | 70 | 75 | 60 |
| in solution | | | | | |
| Weight parts of benzoyl | 1.8 | 1.8 | 2.6 | 2.0 | 1.8 |
| peroxide in solution | | | | | |
| Weight parts of Sample | 100 | 100 | 100 | 100 | 100 |
| prepared in Example 1 | | | | | |

### Example 3—Preparation of Pressure Sensitive Adhesive on Substrate

Each pressure sensitive adhesive curable composition prepare in example 2 was coated on 50 micrometer thick polyethylene terephthalate (PET) film substrate using a coater. Each coated substrate was put into an oven at 70° C. to 80° C. for 2 minutes and then heated in an oven at 165° C. to 180° C. for 2 minutes.

Peeling force was evaluated using the following test method. A second PET film substrate was then applied to the pressure sensitive adhesive. The resulting PSA cured sheets were cut into 1 inch width strips. The second PET film was peeled at a 180° angle while peeling force was measured using an AR-1500 machine using test method ASTM D3330.

Adhesion was evaluated using the following test method. A 1 inch wide strip was applied to a stainless steel (304#) or glass substrate. Each sample was allowed to rest at room temperature for 30 minutes or 1 day. The PET substrate coated with pressure sensitive adhesive was then peeled from the steel or glass substrate. The peeling force was measured using an AR-1500 machine using test method ASTM D3330.

Adhesion stability was evaluated by repeating the above test methods after different storage times for the pressure sensitive adhesive curable composition prepare as described in examples 1 and 2.

Results are shown in the tables below.

TABLE 4
Sample 1 Test Results

| | formulation name/Coat weight | | | |
|---|---|---|---|---|
| | Sample 1 - A/B 0.1- (CW 10~12 um) | | | |
| | different substrates/film storage | | | |
| | RT - | RT - | RT - | RT - |
| | 1 d | 1 week | 2 weeks | 1 month |
| peeling force g/inch | 12 | 28 | 50 | |
| Adhesion(g/inch) Glass - | 30 | 19 | 18 | |
| RT 30 min | | | | |
| Adhesion(g/inch) steel - | 16 | 9 | 9.5 | |
| RT 30 min | | | | |
| Adhesion(g/inch) Glass - | 105.0 | 27 | 24.5 | 17.5 |
| RT 1 d | | | | |
| Adhesion(g/inch) steel - | 18 | 15 | 20 | 11 |
| RT 1 d | | | | |

TABLE 5
Sample 2 Test Results

| | formulation name/coat weight | | | |
|---|---|---|---|---|
| | Sample 2 - A/B 0.1(CW 10~12 um) | | | |
| | different substrates/film storage | | | |
| | RT - | RT - | RT - | RT - |
| | 1 d | 1 week | 2 weeks | 1 month |
| peeling force g/inch | 9 | 16 | 9 | |
| Adhesion(g/inch) Glass - | 14 | 11 | 10 | |
| RT 30 min | | | | |
| Adhesion(g/inch) steel - | 9 | 5 | 3 | |
| RT 30 min | | | | |
| Adhesion(g/inch) Glass - | 29.0 | 17 | 13 | 10.3 |
| RT 1 d | | | | |
| Adhesion(g/inch) steel - | 16 | 14 | 8 | 9.4 |
| RT 1 d | | | | |

TABLE 6
Sample 3 Test Results

| | formulation name/coat weight | | | |
|---|---|---|---|---|
| | Sample 3 (CW 9~12) | | | |
| | different substrates/film storage | | | |
| | RT - | RT - | RT - | RT - |
| | 1 d | 1 week | 2 weeks | 1 month |
| film RT 1 d - peeling | 10 | 14 | 12 | 12 |
| force g/inch | | | | |
| Adhesion(g/inch) Glass - | 15 | 12 | 8.5 | 9.5 |
| RT 30 min | | | | |
| Adhesion(g/inch) steel - | 10 | 7 | 8.6 | 12.5 |
| RT 30 min | | | | |
| Adhesion(g/inch) Glass - | 24.0 | 21 | 25.0 | 17.0 |
| RT 1 d | | | | |
| Adhesion(g/inch) steel - | 23 | 13.5 | 13 | 16.6 |
| RT 1 d | | | | |

TABLE 7
Sample 2 Additional Test Results

| | formulation name/coat weight | | | |
|---|---|---|---|---|
| | Sample 2 - A/B 0.1 (CW 9~12) | | | |
| | different substrates/film storage | | | |
| | RT - | RT - | RT - | RT - |
| | 1 d | 1 week | 2 weeks | 1 month |
| film RT 1 d - peeling | 7.0 | 8 | 7.0 | 10.5 |
| force g/inch | | | | |
| Adhesion(g/inch) Glass - | 9 | 8 | 7 | 9.4 |
| RT 30 min | | | | |
| Adhesion(g/inch) steel - | 6 | 4.5 | 3 | 9 |
| RT 30 min | | | | |
| Adhesion(g/inch) Glass - | 22.0 | 11 | 14.0 | 10.5 |
| RT 1 d | | | | |
| Adhesion(g/inch) steel - | 16 | 7 | 9 | 11.7 |
| RT 1 d | | | | |

TABLE 8
Sample 2 tested after different storage times

| Sample | 2 | 2 | 2 |
|---|---|---|---|
| adhesive storage time | 1 d | 8 d | 43 d |
| CW/um | 11~12 | 10~12 | 10~12 |
| film RT 1 d - peeling | 9 | 7.0 | 8.9 |
| force g/inch | | | |
| Adhesion(g/inch) Glass - | 14 | 9 | 25.4 |
| RT 30 min | | | |
| Adhesion(g/inch) steel - | 9 | 6 | 10.8 |
| RT 30 min | | | |
| Adhesion(g/inch) Glass - | 29.0 | 22.0 | 21.8 |
| RT 1 d | | | |
| Adhesion(g/inch) steel - | 16 | 16 | 16.5 |
| RT 1 d | | | |

TABLE 9
Sample 4 Test Results

| | formulation name/coat weight | | | |
|---|---|---|---|---|
| | Sample 4 (CW 9~12) | | | |
| | different substrates/film storage | | | |
| | RT - | RT - | RT - | RT - |
| | 1 d | 1 week | 2 weeks | 1 month |
| film RT 1 d - peeling | 7.8 | 6.8 | 8.7 | 19.8 |
| force g/inch | | | | |
| Adhesion(g/inch) steel - | 8.0 | 6.8 | 6.6 | 13.1 |
| RT 30 min | | | | |
| Adhesion(g/inch) steel - | 10.2 | 9.8 | 7.4 | 24.5 |
| RT 1 d | | | | |

TABLE 10
Sample 5 Test Results

| | formulation name/coat weight | | | |
|---|---|---|---|---|
| | Sample 5 A/B 0.2 (CW 9~12) | | | |
| | different substrates/film storage | | | |
| | RT - | RT - | RT - | RT - |
| | 1 d | 1 week | 2 weeks | 1 month |
| film RT 1 d - peeling | 12.1 | 9.9 | 8.6 | 13.1 |
| forceg/inch | | | | |
| Adhesion(g/inch) steel - | 7.1 | 8.1 | 10.6 | 7.6 |
| RT 30 min | | | | |
| Adhesion(g/inch) steel - | 12.1 | 14.4 | 10.2 | 14.3 |
| RT 1 d | | | | |

### Example 4—Preparation of Pressure Sensitive Adhesive Compositions

Starting materials A1, B|1 (and B ii 1, if any), and C1 (and G1, if any) were combined and mixed. Starting material D1 or D2, if any was added, and the resulting mixture was mixed for 3 to 5 hours. Starting material E1 or E2, if any, was added, and the resulting mixture was mixed for 2 to 3 hours. A/B ratio (as defined above) and the nonvolatile content (i.e., total amount of silicon containing starting materials) were calculated. The amounts of each starting material (in weight parts) and the calculated values are shown in Table 11, below.

TABLE 11
Weight Parts of Each Starting Material

| | Sample | | | |
|---|---|---|---|---|
| | 6 | 7 | | 9 |
| Starting | (compar- | (compar- | | (compar- |
| Material | ative) | ative) | 8 | ative) |
| A1 | 23.1 | 60.0 | 23.1 | 23.1 |
| B i 1 | 76.9 | 40.0 | 76.9 | 76.9 |
| B ii 1 | 153.9 | 73.3 | 153.9 | 153.9 |
| C1 | 485.5 | 277.5 | 484.2 | 485.6 |
| D1 | 0 | 0.4 | 0.6 | 0 |
| D2 | 0.07 | 0 | 0 | 0 |
| D/(A + B + | | | | |
| D + E) | | | | |
| E1 | 0 | 0.6 | 0.8 | 0 |
| E2 | 0.04 | 0 | 0 | 0 |
| G1 | 7.5 | 4.6 | 7.5 | 7.5 |
| G1/(A + B + | | | | |
| C + D + E + G) | | | | |
| Nonvolatile | 34% | 38% | 34% | 34% |
| Content (NVC) | | | | |
| A/B ratio | 0.1 | 0.5 | 0.1 | 0.1 |

### Example 5—Preparation of Pressure Sensitive Adhesive Curable Compositions

A solution of benzoyl peroxide in solvent was prepared by mixing, 2 weight parts of benzoyl peroxide F1) and 65 weight parts of toluene and xylene mixture C1) for 3 to 5 minutes. Next, the above solution was added to each sample (at 100 weight parts) prepared as described in example 4.

### Example 6—Preparation of Pressure Sensitive Adhesive on Substrate

Each pressure sensitive adhesive curable composition prepared in example 5 was coated on 50 micrometer thick polyethylene terephthalate (PET) film substrate using a coater. Each coated substrate was put into an oven at 70° C. to 80° C. for 2 minutes and then heated in an oven at 165° C. to 180° C. for 2 minutes.

Peeling force was evaluated using the following test method. A second PET film substrate was then applied to the pressure sensitive adhesive. The resulting PSA cured sheets were cut into 1 inch width strips. The second PET film was peeled at a 180° angle while peeling force was measured using an AR-1500 machine using test method ASTM D3330.

Adhesion was evaluated using the following test method. A 1 inch wide strip was applied to a stainless steel (304#) or glass substrate. Each sample was allowed to rest at room temperature for 30 minutes or 1 day. The PET substrate coated with pressure sensitive adhesive was then peeled from the steel or glass substrate. The peeling force was measured using an AR-1500 machine using test method ASTM D3330.

Adhesion stability was evaluated by repeating the above test methods after different storage times for the comparative pressure sensitive adhesive curable composition prepare as described in comparative examples 1C and 2C.

Results are shown in the tables below.

TABLE 12
1 Day Storage Test Results on Comparative Samples

| | 1 d storage comparative samples | | | |
|---|---|---|---|---|
| | 6 | 7 | | 9 |
| | (compar- | (compar- | | (compar- |
| | ative) | ative) | 8 | ative) |
| CW/um | 10~13 | 10~13 | 10~12 | 12~15 |
| film RT 1 d - peeling | 32 | 24.0 | 8 | 28 |
| force g/inch | | | | |
| Adhesion(g/inch) steel - | 22 | 18 | 6 | 27 |
| RT 30 min | | | | |
| Adhesion(g/inch) steel - | 21 | 23 | 9 | 26 |
| RT 1 d | | | | |

After 1 day of storage, comparative samples 6, 7, and 8 each have higher peel force and/or adhesion to steel than sample 8.

TABLE 13
1 Week Storage Test Results on Comparative Samples

| | 1 week storage comparative samples | | | |
|---|---|---|---|---|
| | 6 | 7 | | 9 |
| | (compar- | (compar- | | (compar- |
| | ative) | ative) | 8 | ative) |
| CW/um | 10~13 | 10~13 | 10~12 | 12~15 |
| film RT 1 d - peeling | 27 | 14 | 5 | 36 |
| force g/inch | | | | |
| Adhesion(g/inch) steel - | 12 | 11 | 3 | 19 |
| RT 30 min | | | | |
| Adhesion(g/inch) steel - | 23 | 24 | 8 | 39 |
| RT 1 d | | | | |

After 1 week of storage, comparative samples 6, 7, and 9 had higher peeling force and higher adhesion to steel than sample 8.

TABLE 14
2 Week Storage Test Results on Comparative Samples

| | 2 weeks storage comparative samples | | | |
|---|---|---|---|---|
| | 6 | 7 | | 9 |
| | (compar- | (compar- | | (compar- |
| | ative) | ative) | 8 | ative) |
| CW/um | 10~13 | 10~13 | 10~12 | 12~15 |
| film RT 1 d - peeling | 22 | 17 | 5 | 50 |
| force g/inch | | | | |
| Adhesion(g/inch) steel - | 18 | 15 | 3.5 | 18 |
| RT 30 min | | | | |
| Adhesion(g/inch) steel - | 22 | 25 | 7 | 34 |
| RT 1 d | | | | |

After 2 weeks of storage, comparative samples 6, 7, and 9 had higher peeling force and higher adhesion to steel than sample 8. Furthermore, comparative sample 9 had poor adhesion stability.

### INDUSTRIAL APPLICABILITY

The pressure sensitive adhesive prepared by the method described above is useful in electronics applications, such protection as a masking tape or other protective film. In certain protection applications, it may be desirable for the pressure sensitive adhesive to have good adhesion stability and low release force (e.g., adhesion of 15 g/inch or less to certain substrates, where this value does not increase significantly over time). The pressure sensitive adhesive made by the method and composition described herein has good adhesion stability over time. The pressure sensitive adhesive may have adhesion below 30 g/inch adhesion, alternatively below 20 g/inch, alternatively below 10 g/inch, alternatively 5 to 30 g/inch, alternatively 6 to 20 g/inch, and alternatively 7 to 10 g/inch as measured by ASTM D3330.

### Definitions and Usage of Terms

All amounts, ratios, and percentages are by weight unless otherwise indicated. The Brief Summary of the Invention and the Abstract are hereby incorporated by reference. The articles ‘a’, ‘an’, and ‘the’ each refer to one or more, unless otherwise indicated by the context of specification. The disclosure of ranges includes the range itself and also anything subsumed therein, as well as endpoints. For example, disclosure of a range of 10 to 20 includes not only the range of 10 to 20, but also 11, 12, 13, 15, and 20 individually, as well as any other number subsumed in the range. Furthermore, disclosure of a range of, for example, 10 to 20 includes the subsets of, for example, 10 to 18, 14 to 17, 16 to 18, and 17 to 20, as well as any other subset subsumed in the range.

### Embodiments of the Invention

In a first embodiment, a method for making a pressure sensitive adhesive curable composition comprises:

1) mixing starting materials comprising
A) >0 to 40 weight parts of a polyorganosiloxane resin comprising units of formulae
(R¹₃SiO_{1/2})_{b}(SiO_{4/2})_{c}(HOSiO_{3/2})_{d}, where each R¹ is independently a monovalent hydrocarbon group of 1 to 10 carbon atoms, subscript b is >0, subscript c is >0, and subscript d>0, with the proviso that subscripts b, c, and d have combined values such that the polyorganosiloxane resin has a number average molecular weight of 1,000 to 5,000 and a hydroxyl content of 0.1% to 4%, based on weight of the polyorganosiloxane resin;
B) a polydiorganosiloxane comprising
   i) 60 to <100 weight parts of a silanol-terminated polydiorganosiloxane of formula:

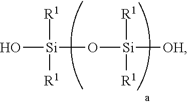

where each R¹ is independently a monovalent hydrocarbon group of 1 to 10 carbon atoms, and subscript a has a value sufficient to give the silanol-terminated polydiorganosiloxane a viscosity of 100 to 200,000 centipoise at 25° C.; and
ii) 0 to 250 weight parts of a silanol terminated polydiorganosiloxane gum having at least two pendent aliphatically unsaturated hydrocarbon groups bonded to silicon atoms per molecule, where the polydiorganosiloxane gum has unit formula (HOR¹⁰2SiO_{1/2})₂(R¹⁰2SiO_{2/2})ₑ(R¹⁰R¹¹SiO_{2/2})_{f}, where subscript e is 0 or greater, subscript f is at least 2, with the proviso that a quantity (e+f) is sufficient to give the silanol terminated polydiorganosiloxane gum a weight average molecular weight of 300,000 to 1,300,000, each R¹⁰ is independently a monovalent hydrocarbon group free of aliphatic unsaturation, and each R¹¹ is independently an aliphatically unsaturated monovalent hydrocarbon group of 2 to 10 carbon atoms; where the starting materials A) and B) are present in amounts sufficient to provide a quantity (A+B i)=100 weight parts, and a weight ratio for amounts of A) and B) of 0<A/B≤0.3; and
C) >30% to <100% by weight, based on the combined weights of starting materials A, B, and C of an organic solvent, thereby forming a mixture;

2) adding to the mixture a starting material comprising D) an amino-functional alkoxysilane;

3) adding, after step 2), a starting material comprising E) a silyl phosphate compound, thereby preparing a pressure sensitive adhesive composition; and

4) adding to the pressure sensitive adhesive composition, a starting material comprising F) a radical cure catalyst comprising an organic peroxide compound, thereby forming the pressure sensitive adhesive curable composition; where at least steps 1), 2), and 3) of the method are performed at a temperature of 0 to 35° C.

A second embodiment, where in the method of the first embodiment, the starting materials further comprise G) a co-solvent comprising an alcohol.

A third embodiment, where in the method the first embodiment or the second embodiment, the amino-functional alkoxysilane comprises aminoethylaminopropyltrimethoxysilane.

A fourth embodiment, where in the method of any one of the preceding embodiments, the silyl phosphate compound comprises a trialkyl silyl hydrogen phosphate.

A fifth embodiment, where the method of any one of the preceding embodiments, further comprises:

5) surface treating a substrate.

A sixth embodiment, where the method of any one of the preceding embodiments, further comprises: 6) applying the pressure sensitive adhesive curable composition to the substrate.

A seventh embodiment, where the method of the sixth embodiment further comprises: 7) drying the pressure sensitive adhesive curable composition to remove all or a portion of the solvent during and/or after step 6).

An eight embodiment, where the method of the sixth embodiment or the method of the seventh embodiment further comprises:

8) curing the pressure sensitive adhesive curable composition to form an adhesive article comprising a pressure sensitive adhesive on the substrate.

A ninth embodiment, where in the method of any one of the sixth, seventh, and eighth embodiments the pressure sensitive adhesive has a thickness of 5 micrometers to 200 micrometers.

A tenth embodiment, where the method of any one of the seventh, eighth and ninth embodiments, further comprises 9) using the adhesive article during processing of electronic parts.

An eleventh embodiment, where a pressure sensitive adhesive curable composition comprises:

I) a reaction product of starting materials comprising
A) >0 to 40 weight parts of a polyorganosiloxane resin comprising units of formulae
(R¹₃SiO_{1/2})_{b}(SiO_{4/2})_{c}(HOSiO_{3/2})_{d}, where each R¹ is independently a monovalent hydrocarbon group of 1 to 10 carbon atoms, subscript b is >0, subscript c is >0, and subscript d>0, with the proviso that subscripts b, c, and d have combined values such that the polyorganosiloxane resin has a number average molecular weight of 1,000 to 5,000 and a hydroxyl content of 0.1% to 4%, based on weight of the polyorganosiloxane resin;
B) a polydiorganosiloxane comprising
   i) 60 to <100 weight parts of a silanol-terminated polydiorganosiloxane of formula:

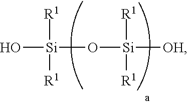

where each R¹ is independently a monovalent hydrocarbon group of 1 to 10 carbon atoms, and subscript a has a value sufficient to give the silanol-terminated polydiorganosiloxane a viscosity of 100 to 200,000 centipoise at 25° C.; and
ii) 0 to 250 weight parts of a silanol terminated polydiorganosiloxane gum having at least two pendent aliphatically unsaturated hydrocarbon groups bonded to silicon atoms per molecule, where the polydiorganosiloxane gum has unit formula (HOR¹⁰2SiO_{1/2})₂(R¹⁰2SiO_{2/2})ₑ(R¹⁰R¹¹SiO_{2/2})_{f}, where subscript e is 0 or greater, subscript f is at least 2, with the proviso that a quantity (e+f) is sufficient to give the silanol terminated polydiorganosiloxane gum a weight average molecular weight of 300,000 to 1,300,000, each R¹⁰ is independently a monovalent hydrocarbon group free of aliphatic unsaturation, and each R¹¹ is independently an aliphatically unsaturated monovalent hydrocarbon group of 2 to 10 carbon atoms; where the starting materials A) and B) are present in amounts sufficient to provide a quantity (A+B i)=100 weight parts, and a weight ratio for amounts of A) and B) of 0<A/B≤0.3; and
D) 0.1% to 1.0% based on combined weights of the starting materials of an amino-functional alkoxysilane;
E) 0.1% to 1.0% based on combined weights of the starting materials of a silyl phosphate compound, thereby preparing a pressure sensitive adhesive composition;
where the reaction product is prepared at a temperature of 0 to 35° C.; and

F) a radical cure catalyst comprising an organic peroxide compound.

A twelfth embodiment, where in the composition of the eleventh embodiment, the starting materials further comprise G) a co-solvent comprising an alcohol.

A thirteenth embodiment, where in the composition of the eleventh or twelfth embodiment, the amino-functional alkoxysilane comprises aminoethylaminopropyltrimethoxysilane.

A fourteenth embodiment, where in the composition of the eleventh or twelfth embodiment, the silyl phosphate compound comprises a trialkyl silyl hydrogen phosphate.

A fifteenth embodiment, where in the composition of any one of the eleventh, twelfth, thirteenth or fourteenth embodiments, the radical cure catalyst comprises an organic peroxide.

A sixteenth embodiment, where the composition of any one of the eleventh, twelfth, thirteenth, fourteenth or fifteenth embodiments, further comprises C) an organic solvent.

1. A method for making a pressure sensitive adhesive curable composition comprising:
1) mixing starting materials comprising
A) >0 to 40 weight parts of a polyorganosiloxane resin comprising units of formulae
(R¹₃SiO_{1/2})_{b}(SiO_{4/2})_{c}(HOSiO_{3/2})_{d}, where each R¹ is independently a monovalent hydrocarbon group of 1 to 10 carbon atoms, subscript b is >0, subscript c is >0, and subscript d>0, with the proviso that subscripts b, c, and d have combined values such that the polyorganosiloxane resin has a number average molecular weight of at least 1,000 and a hydroxyl content of 0.1% to 4%, based on weight of the polyorganosiloxane resin;
B) a polydiorganosiloxane comprising
i) 60 to <100 weight parts of a silanol-terminated polydiorganosiloxane of formula: 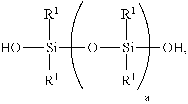
where each R¹ is independently a monovalent hydrocarbon group of 1 to 10 carbon atoms, and subscript a has a value sufficient to give the silanol-terminated polydiorganosiloxane a viscosity of 100 to 200,000 centipoise at 25° C.; and
ii) 0 to 250 weight parts of a silanol terminated polydiorganosiloxane gum having at least two pendent aliphatically unsaturated hydrocarbon groups bonded to silicon atoms per molecule, where the polydiorganosiloxane gum has unit formula (HOR¹⁰2SiO_{1/2})₂(R¹⁰2SiO_{2/2})ₑ(R¹⁰R¹¹SiO_{2/2})_{f}, where subscript e is 0 or greater, subscript f is at least 2, with the proviso that a quantity (e+f) is sufficient to give the silanol terminated polydiorganosiloxane gum a weight average molecular weight of 300,000 to 1,300,000, each R¹⁰ is independently a monovalent hydrocarbon group free of aliphatic unsaturation, and each R¹¹ is independently an aliphatically unsaturated monovalent hydrocarbon group of 2 to 10 carbon atoms; where the starting materials A) and B) are present in amounts sufficient to provide a quantity (A+B i)=100 weight parts, and a weight ratio for amounts of A) and B) of 0<A/B≤0.3; and
C) >30% to <100% by weight, based on the combined weights of starting materials A, B, and C of an organic solvent, thereby forming a mixture;
2) adding to the mixture a starting material comprising D) an amino-functional alkoxysilane;
3) adding, after step 2), a starting material comprising E) a silyl phosphate compound, thereby preparing a pressure sensitive adhesive composition; and
4) adding to the pressure sensitive adhesive composition, a starting material comprising F) a radical cure catalyst comprising an organic peroxide compound, thereby forming the pressure sensitive adhesive curable composition; where at least steps 1), 2), and 3) of the method are performed at a temperature no greater than 35° C.

2. The method of claim 1, where the starting materials further comprise G) a co-solvent comprising an alcohol.

3. The method of claim 1, where the amino-functional alkoxysilane comprises aminoethylaminopropyltrimethoxysilane.

4. The method of claim 1, where the silyl phosphate compound comprises a trialkyl silyl hydrogen phosphate.

5. The method of claim 1, further comprising:
optionally 5) surface treating a substrate, and
6) applying the pressure sensitive adhesive curable composition to the substrate.

6. The method of claim 5, further comprising
optionally 7) drying the pressure sensitive adhesive curable composition to remove all or a portion of the solvent during and/or after step 6), and
8) curing the pressure sensitive adhesive curable composition to form an adhesive article comprising a pressure sensitive adhesive on the substrate.

7. The method of claim 6, where the pressure sensitive adhesive has a thickness of 5 micrometers to 200 micrometers.

8. The method of claim 6, where the method further comprises 9) using the adhesive article during processing of electronic parts.

9. A pressure sensitive adhesive curable composition comprising:
I) a reaction product of starting materials comprising
A) >0 to 40 weight parts of a polyorganosiloxane resin comprising units of formulae
(R¹₃SiO_{1/2})_{b}(SiO_{4/2})_{c}(HOSiO_{3/2})_{d}, where each R¹ is independently a monovalent hydrocarbon group of 1 to 10 carbon atoms, subscript b is >0, subscript c is >0, and subscript d>0, with the proviso that subscripts b, c, and d have combined values such that the polyorganosiloxane resin has a number average molecular weight of at least 1,000 and a hydroxyl content of 0.1% to 4%, based on weight of the polyorganosiloxane resin;
B) a polydiorganosiloxane comprising
i) 60 to <100 weight parts of a silanol-terminated polydiorganosiloxane of formula: 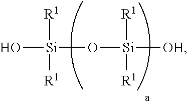
where each R¹ is independently a monovalent hydrocarbon group of 1 to 10 carbon atoms, and subscript a has a value sufficient to give the silanol-terminated polydiorganosiloxane a viscosity of 100 to 200,000 centipoise at 25° C.; and
ii) 0 to 250 weight parts of a silanol terminated polydiorganosiloxane gum having at least two pendent aliphatically unsaturated hydrocarbon groups bonded to silicon atoms per molecule, where the polydiorganosiloxane gum has unit formula (HOR¹⁰2SiO_{1/2})₂(R¹⁰2SiO_{2/2})ₑ(R¹⁰R¹¹SiO_{2/2})_{f}, where subscript e is 0 or greater, subscript f is at least 2, with the proviso that a quantity (e+f) is sufficient to give the silanol terminated polydiorganosiloxane gum a weight average molecular weight of 300,000 to 1,300,000, each R¹⁰ is independently a monovalent hydrocarbon group free of aliphatic unsaturation, and each R¹¹ is independently an aliphatically unsaturated monovalent hydrocarbon group of 2 to 10 carbon atoms; where the starting materials A) and B) are present in amounts sufficient to provide a quantity (A+B i)=100 weight parts, and a weight ratio for amounts of A) and B) of 0<A/B≤0.3; and
D) 0.1% to 1.0% based on combined weights of the starting materials of an amino-functional alkoxysilane;
E) 0.1% to 1.0% based on combined weights of the starting materials of a silyl phosphate compound, thereby preparing a pressure sensitive adhesive composition; and
optionally C) an organic solvent;
F) a radical cure catalyst comprising an organic peroxide compound.

10. The composition of claim 9, where the starting materials further comprise G) a co-solvent comprising an alcohol.

11. The composition of claim 9, where the amino-functional alkoxysilane comprises aminoethylaminopropyltrimethoxysilane.

12. The composition of claim 9, where the silyl phosphate compound comprises a trialkyl silyl hydrogen phosphate.

13. The composition of claim 9, where the radical cure catalyst comprises an organic peroxide.

14. The method of claim 2, where the amino-functional alkoxysilane comprises aminoethylaminopropyltrimethoxysilane.

15. The method of claim 2, where the silyl phosphate compound comprises a trialkyl silyl hydrogen phosphate.

16. The method of claim 2, further comprising:
optionally 5) surface treating a substrate, and
6) applying the pressure sensitive adhesive curable composition to the substrate.

17. The composition of claim 10, where the amino-functional alkoxysilane comprises aminoethylaminopropyltrimethoxysilane.

18. The composition of claim 10, where the silyl phosphate compound comprises a trialkyl silyl hydrogen phosphate.

19. The composition of claim 10, where the radical cure catalyst comprises an organic peroxide.
